(19) United States
(12) Patent Application Publication
(10) Pub. No.: US 2026/0237561 A1
(43) Pub. Date: Aug. 13, 2026

(54) MULTILAYER CERAMIC ELECTRONIC COMPONENT AND MANUFACTURING METHOD OF THE SAME

(71) Applicant: TAIYO YUDEN CO., LTD., Tokyo (JP)

(72) Inventor: Kunihiko NAGAOKA, Tokyo (JP)

(73) Assignee: TAIYO YUDEN CO., LTD., Tokyo (JP)

(21) Appl. No.: 19/446,966

(22) Filed: Jan. 13, 2026

(30) Foreign Application Priority Data
Feb. 7, 2025 (JP) 2025-019363

(51) Int. Cl. H01G 4/008; H01G 4/12; H01G 4/232; H01G 4/30

(52) U.S. Cl. CPC H01G 4/008; H01G 4/30; H01G 4/12; H01G 4/232

(57) ABSTRACT

A multilayer ceramic electronic component includes a substantially rectangular parallelepiped multilayer body in which a plurality of dielectric layers, a plurality of first internal electrode layers, and a plurality of second internal electrode layers are laminated, wherein an average thickness of each of the plurality of first internal electrode layers is different from an average thickness of each of the plurality of second internal electrode layers, and wherein the each of the plurality of first internal electrode layers and the each of the plurality of second internal electrode layers are alternately laminated with each of the plurality of dielectric layers interposed therebetween.

### CROSS-REFERENCE TO RELATED APPLICATION

This application is based upon and claims the benefits of priorities of Japanese Patent Application No. 2025-019363 filed on Feb. 7, 2025, the entire contents of which are incorporated herein by reference.

### FIELD

A certain aspect of the present disclosure relates to a multilayer ceramic electronic component and a manufacturing method of the same.

### BACKGROUND

In response to the demand for a multilayer ceramic capacitor with a higher capacitance, internal electrodes in its ceramic body have been made thinner so that the number of layers in the ceramic body increases (Refer to, for example, Japanese Examined Patent Publication No. 2019-176120).

### SUMMARY OF THE INVENTION

According to a first aspect of the present disclosure, there is provided a multilayer ceramic electronic component including: a substantially rectangular parallelepiped multilayer body in which a plurality of dielectric layers, a plurality of first internal electrode layers, and a plurality of second internal electrode layers are laminated, wherein an average thickness of each of the plurality of first internal electrode layers is different from an average thickness of each of the plurality of second internal electrode layers, and wherein the each of the plurality of first internal electrode layers and the each of the plurality of second internal electrode layers are alternately laminated with each of the plurality of dielectric layers interposed therebetween.

According to a second aspect of the present disclosure, there is provided a manufacturing method of a multilayer ceramic electronic component, including: forming a first green sheet by applying a ceramic slurry onto a base substrate; forming a first internal electrode pattern by applying conductive paste onto the first green sheet; forming a second green sheet by applying a ceramic slurry onto the first green sheet and the first internal electrode pattern; forming a second internal electrode pattern having an average thickness different from that of the first internal electrode pattern by applying conductive paste onto the second green sheet; peeling the first green sheet and the second green sheet from the base substrate; laminating and pressure-bonding a plurality of sets of the first green sheet and the second green sheet; dividing the plurality of sets of the first green sheet and the second green sheet which have been pressure-bonded into a plurality of laminated bodies along a lamination direction; and firing the laminated body.

### BRIEF DESCRIPTION OF THE DRAWINGS

FIG. 1 is a perspective view of a multilayer ceramic capacitor according to an embodiment of the present invention.

FIG. 2 is a sectional view taken along the line A-A in FIG. 1.

FIG. 3 is a sectional view taken along the line B-B in FIG. 1.

FIG. 4 is an enlarged sectional view of the vicinity of an external electrode.

FIG. 5 is an enlarged sectional view illustrating an example of a part of the capacitance section.

FIG. 6 is a flowchart illustrating an example of a method of manufacturing the multilayer ceramic capacitor.

FIGS. 7A to 7D are diagrams illustrating an example of processes from a green sheet formation process to an internal electrode pattern formation process.

FIG. 8 is a diagram illustrating an example of a lamination and pressure bonding process.

### DETAILED DESCRIPTION

When the number of layers increases and the thickness of the internal electrode decreases, a difference in an amount of contraction between the internal electrode and the adjacent dielectric margin region increases in firing step of manufacturing the multilayer ceramic capacitor, and cracking and delamination of the internal electrodes are likely to occur. Therefore, the reliability of the multilayer ceramic capacitor may be reduced.

### Embodiment

### Configuration of Multilayer Ceramic Capacitor

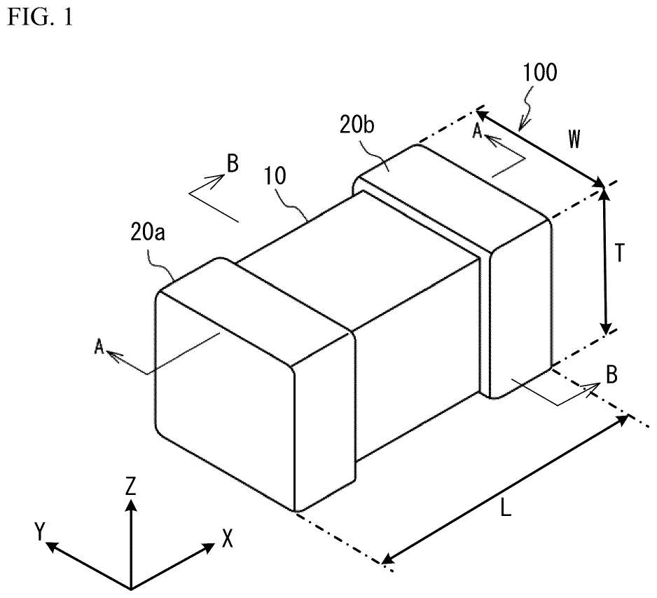

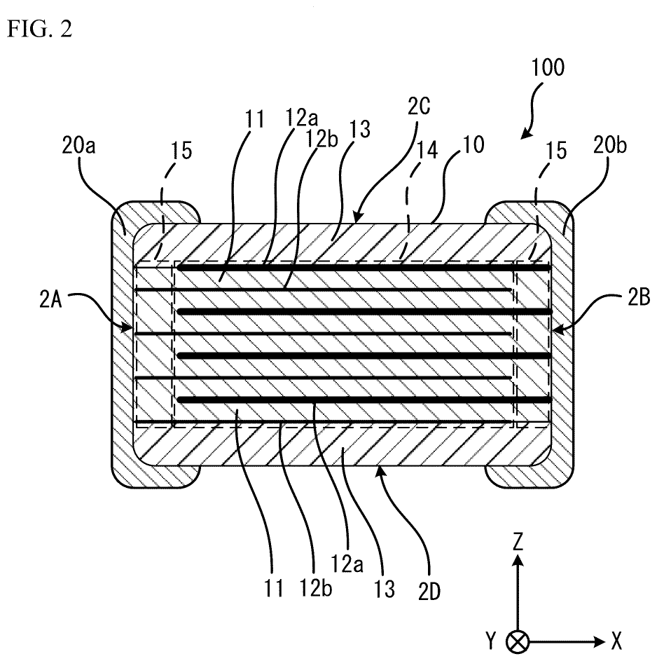

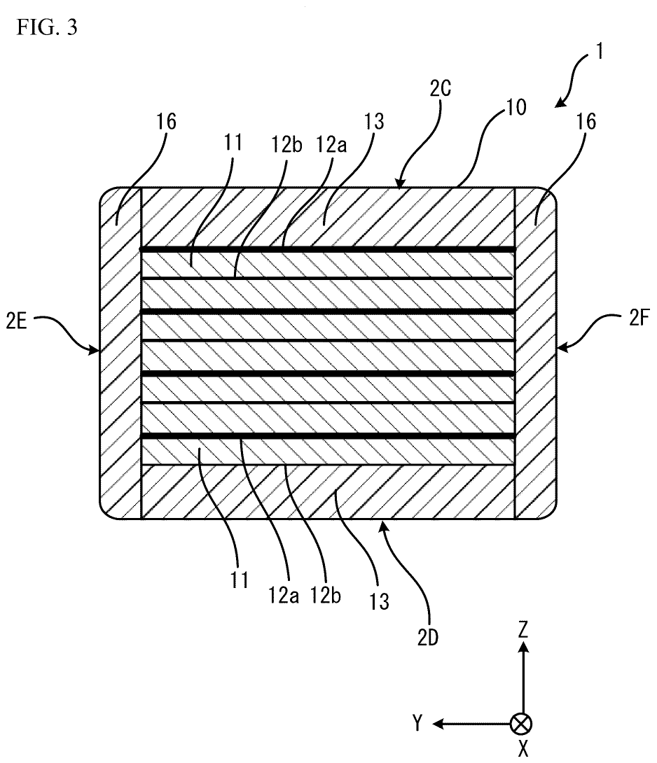

FIG. 1 is a perspective view of a multilayer ceramic capacitor 100 according to an embodiment of the present invention. FIG. 2 is a sectional view taken along the line A-A in FIG. 1. FIG. 3 is a sectional view taken along the line B-B in FIG. 1.

The multilayer ceramic capacitor 100 is an example of a multilayer ceramic electronic component. As illustrated in FIGS. 1 to 3, the multilayer ceramic capacitor 100 includes an element body 10 having a substantially rectangular parallelepiped shape and external electrodes 20a and 20b provided on two opposing end surfaces 2A and 2B of the element body 10. Of the four surfaces of the element body 10 other than the two end surfaces 2A and 2B, two surfaces other than an upper surface 2C and a lower surface 2D in a lamination direction are referred to as side surfaces 2E and 2F. The external electrodes 20a and 20b extend to the upper surface 2C, the lower surface 2D, and the two side surfaces 2E and 2F of the element body 10 in the lamination direction. However, the external electrodes 20a and 20b are spaced apart from each other.

In FIGS. 1 to 3, the Z-axis direction (first direction) is the lamination direction, and is a direction in which the internal electrode layers 12a and 12b face each other. The X-axis direction (second direction) is a length direction of the element body 10, in which the two end surfaces 2A and 2B of the element body 10 face each other, and in which the external electrode 20a and the external electrode 20b face each other. The Y-axis direction (third direction) is a width direction of the internal electrode layers 12a and 12b, and is a direction in which the two side surfaces 2E and 2F of the element body 10 face each other. The X-axis direction, the Y-axis direction, and the Z-axis direction are perpendicular to each other.

The element body 10 is a multilayer body in which dielectric layers 11 containing a ceramic material functioning as a dielectric and internal electrode layers 12a and 12b are alternately laminated. The edge of the internal electrode layer 12b is exposed to the end surface 2A of the element body 10 on which the external electrode 20a is provided, and the edge of the internal electrode layer 12a is exposed to the end surface 2B on which the external electrode 20b is provided. Thus, the internal electrode layer 12b is electrically connected to the external electrode 20a, and the internal electrode layer 12a is electrically connected to the external electrode 20b.

The internal electrode layers 12a and 12b are alternately laminated with the dielectric layer 11 interposed therebetween in the lamination direction. As a result, the multilayer ceramic capacitor 100 has a configuration in which a plurality of sets of the internal electrode layers 12a and 12b face each other with the dielectric layer 11 interposed therebetween. In the multilayer body including the dielectric layers 11 and the internal electrode layers 12a and 12b, the internal electrode layers 12a and 12b are arranged on the outermost layer in the lamination direction, and the upper surface 2C and the lower surface 2D of the multilayer body are covered with a cover layer 13. The cover layer 13 is mainly composed of a ceramic material. For example, the cover layer 13 may have the same composition as the dielectric layer 11 or different composition from the dielectric layer 11. The configuration is not limited to the one shown in FIGS. 1 to 3 as long as the internal electrode layers 12a and 12b are exposed to the two different end surfaces 2B and 2A and are electrically connected to the different external electrodes 20b and 20a.

The size of the multilayer ceramic capacitor 100 is, for example, a length of 0.25 m, a width of 0.125 mm, and a height of 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes.

The internal electrode layers 12a and 12b are mainly composed of a base metal such as nickel (Ni), copper (Cu), or tin (Sn), or an alloy containing these metals. The inner internal electrode layers 12a and 12b may be made of a noble metal such as platinum (Pt), palladium (Pd), silver (Ag), or gold (Au), or an alloy containing these metals.

The dielectric layer 11 has, for example, a ceramic material having a perovskite structure represented by a general formula ABO₃ as a main phase. The perovskite structure contains ABO_{3-α}that is not in the stoichiometric composition. In the present embodiment, barium titanate (BaTiO₃) is used as a main component ceramic of the dielectric layer 11. The main component ceramic of the dielectric layer 11 contains, for example, BaTiO₃ (barium titanate), CaZrO₃ (calcium zirconate), CaTiO₃ (calcium titanate), SrTiO₃ (strontium titanate), MgTiO₃ (magnesium titanate), and Ba_{1-x-y}CaₓSr_{y}Ti_{1-z}Zr_{z}O₃ (0≤x≤1, 0≤y≤1,0≤z≤1) forming a perovskite structure can be selected and used. Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, and the like.

As illustrated in FIG. 2, the section where the internal electrode layer 12b connected to the external electrode 20a and the internal electrode layer 12a connected to the external electrode 20b face each other is a section where an electric capacitance is generated in the multilayer ceramic capacitor 100. Therefore, the section where the electric capacitance is generated is referred to as a capacitance section 14. That is, the capacitance section 14 is a region where the adjacent internal electrode layers 12b and 12a connected to the different external electrodes 20a and 20b face each other.

A region where the internal electrode layers 12b connected to the external electrode 20a face each other without being interposed by the internal electrode layers 12a connected to the external electrode 20b is referred to as an end margin 15. A region where the internal electrode layers 12a connected to the external electrode 20b face each other without being interposed by the internal electrode layers 12b connected to the external electrode 20a is also the end margin 15. That is, the end margin 15 is a region where the internal electrode layers 12b and 12a connected to the same external electrodes 20a and 20b face each other without being interposed by the internal electrode layers 12a and 12b connected to the different external electrodes 20b and 20a. The end margin 15 is a region where no electric capacitance is generated.

As illustrated in FIG. 3, in the element body 10, the side margin 16 is a region provided so as to cover end portions (end portions in the Y axis direction) of the dielectric layers 11 and the internal electrode layers 12a and 12b on sides of the two side surfaces 2E and 2F. That is, the side margin 16 is a region provided outside of the capacitance section 14 in the Y-axis direction. The side margin 16 is also a region where no electric capacitance is generated.

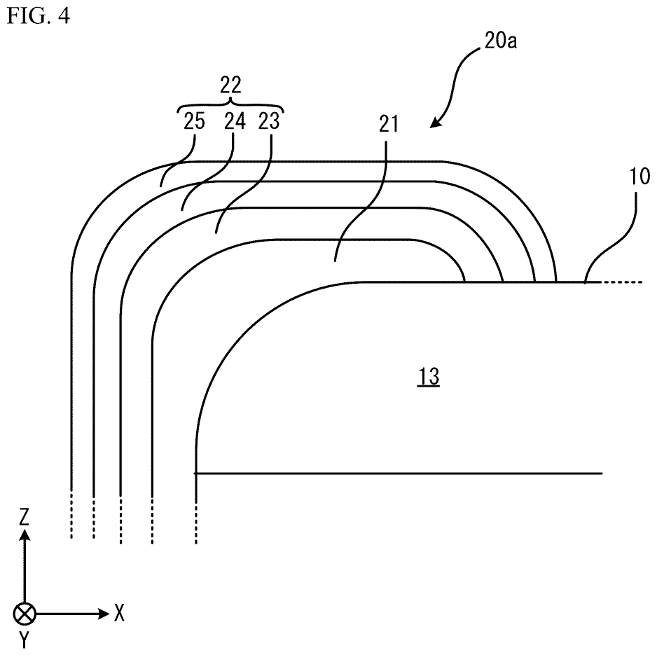

FIG. 4 is an enlarged sectional view of the vicinity of an external electrode 20a. In FIG. 4, the hatch representing a cross section is omitted. The external electrode 20a has a structure in which a plating layer 22 is provided on an underlying layer 21. The underlying layer 21 is mainly composed of nickel, copper, or the like. The underlying layer 21 may contain ceramic grains or glass components as the co-material. The plating layer 22 is mainly composed of a metal such as nickel, copper, aluminum, zinc, tin, or an alloy of two or more of these metals. The plating layer 22 may be a plating layer of a single metal component or a plurality of plating layers with different metal components. For example, the plating layer 22 has a structure in which a first plating layer 23, a second plating layer 24, and a third plating layer 25 are formed in this order from the underlying layer 21 side. The first plating layer 23 is, for example, a copper plating layer. The second plating layer 24 is, for example, a nickel plating layer. The third plating layer 25 is, for example, a tin plating layer. The other external electrode 20b has the same configuration as that of the external electrode 20a.

### Thickness of Internal Electrode Layers

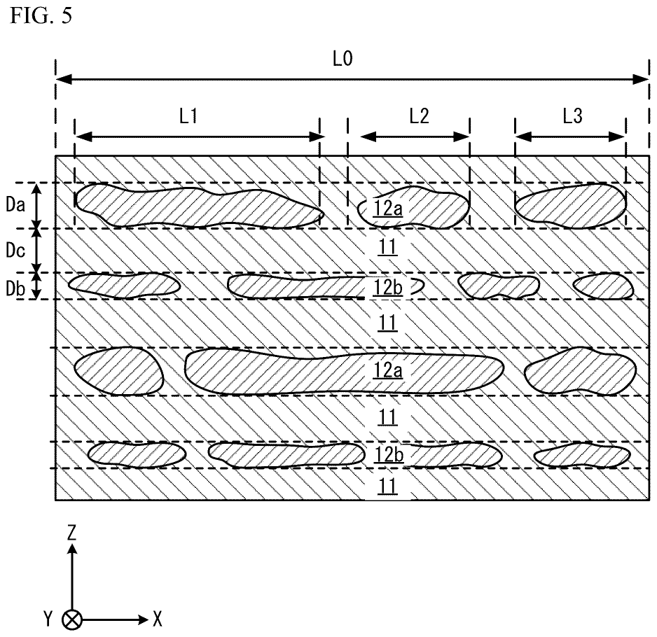

FIG. 5 is an enlarged sectional view illustrating an example of a part of the capacitance section 14. The average thicknesses Da and Db of the internal electrode layers 12a and 12b in the Z-axis direction are different from each other. The average thickness Da of the internal electrode layer 12a is larger than the average thickness Db of the internal electrode layer 12b. The internal electrode layers 12a and 12b are examples of the first and second internal electrode layers respectively.

As described above, the element body 10 has a structure where the internal electrode layers 12a with the larger average thickness Da and the internal electrode layers 12b with the smaller average thickness Db are alternately laminated with interposing of the dielectric layers 11 in the lamination direction. Therefore, in the manufacture of the multilayer ceramic capacitor 100, when the element body 10 is sintered, a difference in the sintering property between the internal electrode layers 12a and 12b can be obtained. Specifically, a difference in the average thicknesses Da and Db causes, for example, an amount and a timing of shrinkage of the internal electrode layers 12a and 12b to differ during sintering in the manufacturing process of the multilayer ceramic capacitor 100, and as a result, due to a difference in the amount and the timing of shrinkage between the internal electrode layers 12a and 12b, the dielectric regions such as the side margin 16, the cover layer 13, or the like adjacent to the periphery of a multilayer region of the dielectric layers 11 are substantially uniformly reduced in the lamination direction.

Therefore, compared with the case where the average thicknesses Da and Db are the same, the stress due to the contraction of the internal electrode layers 12a and 12b can be dispersed. This suppresses the occurrence of cracks in the multilayer body and improves the reliability of the multilayer ceramic capacitor 100.

The average thickness of the internal electrode layers 12a and 12b can be measured by observing the cross section of the multilayer ceramic capacitor 100 with a scanning electron microscope (SEM), measuring the thickness of each of the ten internal electrode layers 12a and 12b, and calculating the average value of all the measurement points. The average thickness per layer of the internal electrode layer 12 a in the Z-axis direction is, for example, 0.2 μm or more and 0.9 μm or less, preferably 0.3 μm or more and 0.9 μm or less, and more preferably 0.4 μm or more and 0.9 μm or less. Also, the average thickness of the internal electrode layer 12b per layer in the Z-axis direction is, for example, 0.25 μm or more and 0.6 μm or less, preferably 0.25 μm or more and 0.5 μm or less, and more preferably 0.25 μm or more and 0.4 μm or less.

Also, the average thickness of the dielectric layer 11 can be measured by observing the dielectric layer 11, measuring the thickness of each of the ten different dielectric layers 11 at ten points, and calculating the average value of all the measurement points. The average thickness per layer of the dielectric layer 11 in the Z-axis direction is, for example, 0.2 μm or more and 0.9 μm or less, preferably 0.3 μm or more and 0.9 μm or less, and more preferably 0.4 μm or more and 0.9 μm or less.

In order to more effectively suppress the occurrence of cracks, the ratio of the average thickness of one internal electrode layer 12a to the average thickness of the other internal electrode layer 12b is preferably 1.05 or more. More preferably, the ratio of the average thickness of one internal electrode layer 12a to the average thickness of the other internal electrode layer 12b may be 1.1 or more. Furthermore, the ratio of the average thickness of one internal electrode layer 12a to the average thickness of the other internal electrode layer 12b may be 1.2 or more.

In order to more effectively suppress the occurrence of cracks, the ratio of the average thickness of one internal electrode layer 12a to the average thickness of the other internal electrode layer 12b is preferably 2.0 or less. More preferably, the ratio of the average thickness of one internal electrode layer 12a to the average thickness of the other internal electrode layer 12b may be 1.8 or less. Furthermore, the ratio of the average thickness of one internal electrode layer 12a to the average thickness of the other internal electrode layer 12b may be 1.7 or less.

The average continuity moduli of the internal electrode layers 12a and 12b are different from each other. The average continuity modulus of the internal electrode layer 12a is higher than that of the internal electrode layer 12b. Here, the average continuity modulus is, for example, can be defined as Σ Ln/L0 (Σ Ln=L1+L2+·+Ln), where the metal part length L1, L2, . . . , Ln (n: a positive integer. In this example, n=3) in an observed area with the length L0 of the internal electrode layers 12a and 12b within a cross-section along the lamination direction of the element body 10 are measured and summed up.

A difference in the average continuity modulus between the internal electrode layers 12a and 12b is caused by the difference in the amount of shrinkage of the internal electrode layers 12a and 12b during sintering, as described above. The difference in the amount of shrinkage is adjusted by, for example, an amount of a conductive paste to form the internal electrode layers 12a and 12b, a concentration of rare earth elements added to the conductive paste, or a concentration of a ceramic component added to the conductive paste as a co-material. Additionally, the average continuity modulus can be adjusted by a grain size of metal grains such as nickel grains to form the internal electrode layers 12a and 12b.

In order to more effectively suppress the occurrence of cracks, the difference in the average continuity modulus of the internal electrode layers 12a and 12b is preferably 3% or more. For example, when the average continuity modulus of the one internal electrode layer 12a is 80%, the average continuity modulus of the other internal electrode layer 12b may be 77% or less, or 83% or more. More preferably, the difference in the average continuity modulus of the internal electrode layers 12a and 12b may be 5% or more. Further, the difference in the average continuity modulus of the internal electrode layers 12a and 12b may be 6% or more.

In order to more effectively suppress the occurrence of cracks, the difference in the average continuity modulus of the internal electrode layers 12a and 12b is preferably 10% or less. More preferably, the difference between the average continuity moduli of the internal electrode layers 12a and 12b may be 9% or less. Further, the difference between the average continuity moduli of the internal electrode layers 12a and 12b may be 8% or less.

As described above, each of the internal electrode layers 12a and 12b may contain a rare earth element. Examples of the rare earth element include, but are not limited to, holmium and dysprosium. The concentration of the rare earth element in the internal electrode layer 12a is higher than that in the internal electrode layer 12b. Therefore, during sintering, the rare earth element prevents a contact between the internal electrode layers 12a and 12b, and the amount of contraction of the internal electrode layer 12a is suppressed more than that of the internal electrode layer 12b.

In order to more effectively suppress the occurrence of cracks, a difference in the concentration of the rare earth element between the internal electrode layers 12a and 12b may be 5 at % or more. More preferably, the difference in the concentration of the rare earth element between the internal electrode layers 12a and 12b may be 6 at % or more. Further, the difference in the concentration of the rare earth element between the internal electrode layers 12a and 12b may be 7 at % or more.

In order to more effectively suppress the occurrence of cracks, the difference in the concentration of the rare earth element between the internal electrode layers 12a and 12b may be 12 at % or less. More preferably, the difference in the concentration of the rare earth element between the internal electrode layers 12a and 12b may be 10 at % or less. Further, the difference in the concentration of the rare earth element between the internal electrode layers 12a and 12b may be 8 at % or less.

Also, as described above, each of the internal electrode layers 12a and 12b may contain a ceramic component. The ceramic component is added as a co-material to the conductive paste forming the internal electrode layers 12a and 12b in the manufacturing process of the multilayer ceramic capacitor. The ceramic component may be similar to the main components of the dielectric layer 11, the cover layer 13, the end margin 15, and the side margin 16, for example. A concentration of the ceramic component in the internal electrode layer 12a is higher than that in the internal electrode layer 12b. Therefore, during sintering, the amount of shrinkage of the internal electrode layer 12a is close to an amount of shrinkage of the end margin 15 and the side margin 16, and is suppressed more than the amount of shrinkage of the internal electrode layer 12b.

In order to more effectively suppress the occurrence of cracks, a difference in the concentration of the ceramic component between the internal electrode layers 12a and 12b may be 0.1 at % or more. More preferably, the difference in the concentration of the ceramic component between the internal electrode layers 12a and 12b may be 0.15 at % or more. Further, the difference in the concentration of the ceramic component between the internal electrode layers 12a and 12b may be 0.2 at % or more.

In order to more effectively suppress the occurrence of cracks, the difference in the concentration of the ceramic component between the internal electrode layers 12a and 12b may be 1.0 at % or less. More preferably, the difference in the concentration of the ceramic component between the internal electrode layers 12a and 12b may be 0.8 at % or less. Further, the difference in the concentration of the ceramic component between the internal electrode layers 12a and 12b may be 0.6 at % or less.

Additionally, the above-described structure of the internal electrode layers 12a and 12b is not necessarily applied to all the internal electrode layers 12a and 12b of the multilayer ceramic capacitor 100, but may be applied to at least some of the internal electrode layers 12a and 12b.

### Manufacturing Process of Multilayer Ceramic Capacitor

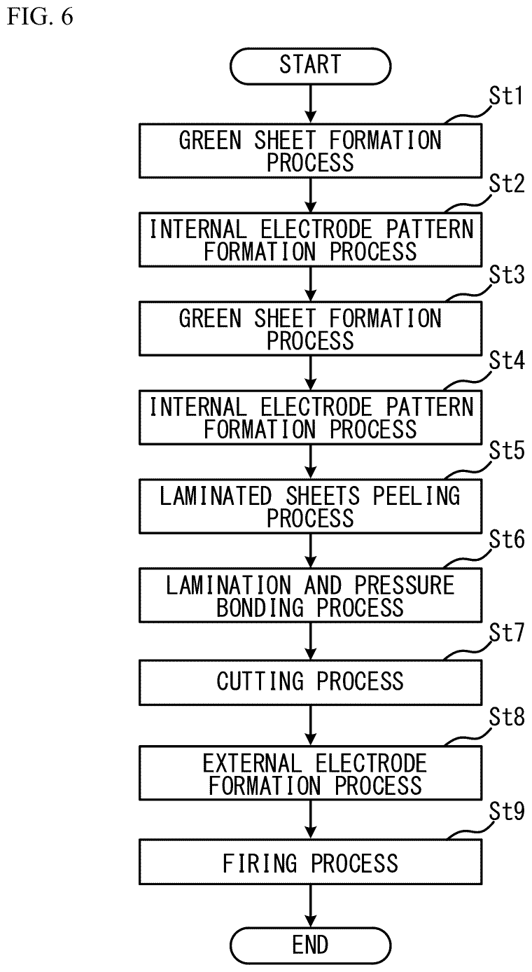

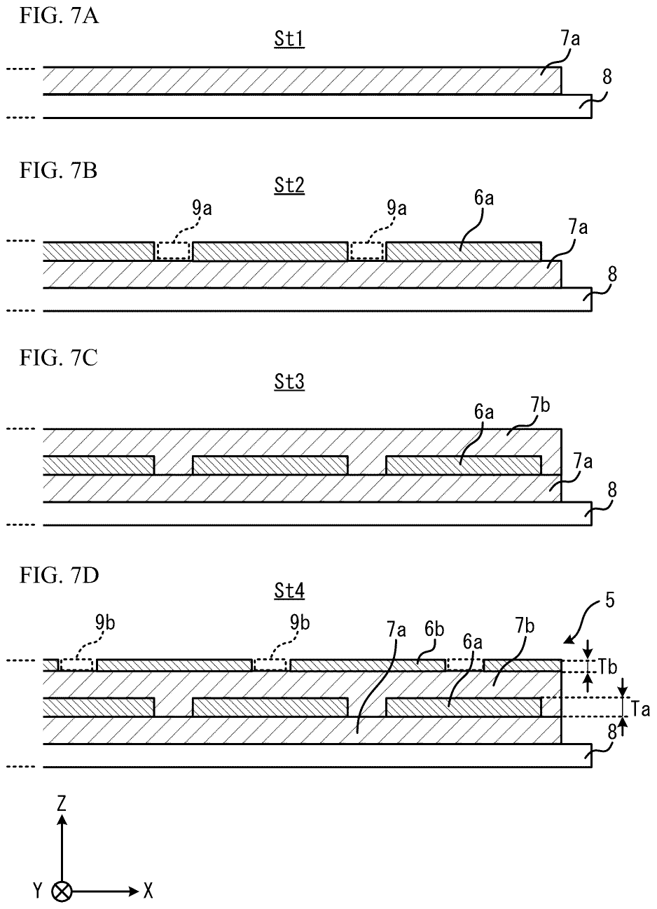

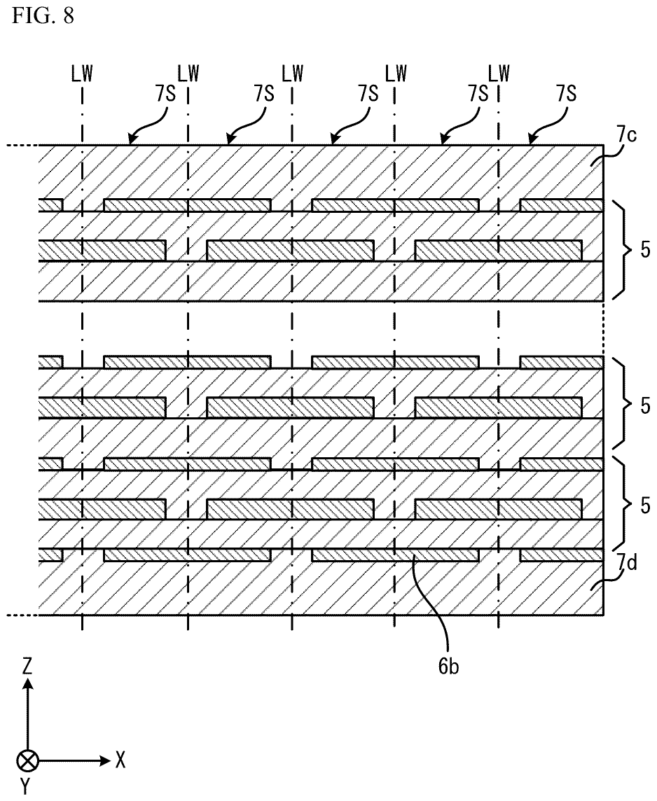

FIG. 6 is a flowchart illustrating an example of a method of manufacturing the multilayer ceramic capacitor 100. FIGS. 7A to 7D are diagrams illustrating an example of processes from a green sheet formation process St1 to an internal electrode pattern formation process St6. FIG. 8 is a diagram illustrating an example of a lamination and pressure bonding process St6. FIGS. 7A to 8 are cross sections of the multilayer body taken along the X and Z directions, respectively. Also, this manufacturing process is an example of a method of manufacturing a multilayer ceramic electronic component.

### Green Sheet Formation Process St1

In this process, a green sheet 7a is formed by applying a ceramic slurry onto a base substrate 8. The ceramic slurry is obtained by adding a binder such as polyvinyl butyral (PVB) resin, an organic solvent such as ethanol or toluene, and a plasticizer to a dielectric material obtained by adding various additive compounds (sintering aid, etc.) to ceramic powder, and then wet-mixing the mixture. The green sheet 7a is coated on the base substrate 8 by, for example, a die coater method or a doctor blade method using the ceramic slurry and dried. The base substrate 8 is, for example, a PET (polyethylene terephthalate) film.

As an additive compound of the ceramic powder, oxides of Mg (magnesium), Mn (manganese), V (vanadium), Cr (chromium), rare earth elements (Y (yttrium), Sm (samarium), Eu (europium), Gd (gadolinium), Tb (terbium), Dy (dysprosium), Ho (holmium), Er (erbium), Tm (thulium) and Yb (ytterbium)), and oxides or glasses of Co (cobalt), Ni (nickel), Li (lithium), B (boron), Na (sodium), K (potassium) and Si (silicon) are used.

### Internal Electrode Pattern Formation Process St2

In this process, internal electrode patterns 6a are formed on the green sheet 7a by applying conductive paste to which ceramic particles are added. After the multilayer body is fired, the green sheet 7a becomes the dielectric layers 11, and the internal electrode patterns 6a become the internal electrode layers 12a. Additionally, the green sheet 7a is an example of a first green sheet, and the internal electrode pattern 6a is an example of an internal electrode pattern.

The conductive paste of a metal for forming internal electrodes, containing an organic binder, is printed on the green sheet 7a by gravure printing or the like, whereby a plurality of the internal electrode patterns 6a is formed so as to be spaced from each other. The ceramic particles are added to the conductive paste as a co-material. The main component of the ceramic particles is not particularly limited, but is preferably the same as the main component of the ceramic of the dielectric layer 11. Additionally, the formation process of the internal electrode pattern 6a is not limited to printing, and may be a vacuum deposition method such as sputtering.

### Green Sheet Formation Process St3

In this process, a ceramic slurry similar to the ceramic slurry used in the green sheet formation process St1 is applied onto the green sheet 7a and the internal electrode pattern 6a to form a green sheet 7b. Here, before the application of the ceramic slurry, the same ceramic slurry is also applied to gaps 9a between the internal electrode patterns 6a. Therefore, a level difference between the internal electrode patterns 6a and the green sheet 7a is reduced.

### Internal Electrode Pattern Formation Process St4

In this process, like the internal electrode pattern formation process St2, internal electrode patterns 6b are formed on the green sheet 7b by applying conductive paste to which ceramic particles are added. Here, a plurality of the internal electrode patterns 6b is formed on the green sheet 7b so as to be spaced from each other. The internal electrode patterns 6a and 6b are formed so as to be shifted from each other by a half pitch in the X direction. After the multilayer body is fired, the green sheet 7b becomes the dielectric layers 11, and the internal electrode patterns 6b become the internal electrode layers 12b. Additionally, the green sheet 7b is an example of a second green sheet, and the internal electrode pattern 6a is an example of an internal electrode pattern.

The internal electrode patterns 6b are formed to have an average thickness different from that of the internal electrode patterns 6a. A difference in the average thickness of the internal electrode patterns 6a and 6b may be adjusted by, for example, an amount of the conductive paste applied to the green sheets 7a and 7b, or an amount of the ceramic component added to the conductive paste as a co-material.

That is, in the internal electrode pattern formation process St2 and St4, the amount of the conductive paste applied or the amount of the ceramic component added to the conductive paste is different from each other. Thus, the average thickness Tb of the internal electrode patterns 6b become smaller than the average thickness Ta of the internal electrode patterns 6a. Therefore, after the multilayer body is fired, the internal electrode layers 12a and 12b having the average thicknesses Da and Db different from each other are formed.

As described above, different amounts of rare earth elements may be added to the internal electrode patterns 6a and 6b so as to effectively vary the amount of contraction of the internal electrode layers 12a and 12b. That is, the addition of the rare earth element to the conductive paste in the internal electrode pattern formation processes St2 and St4 may be different from each other.

After the formation of the internal electrode patterns 6b, the same ceramic slurry as described above is applied to gaps 9b between the internal electrode patterns 6b. Therefore, a level difference between the internal electrode pattern 6b and the green sheet 7b is reduced.

### Laminated Sheets Peeling Process St5

A laminated sheets 5 obtained by the above processes have two layers of the green sheets 7a and 7b and the internal electrode patterns 6a and 6b. The laminated sheets 5 are peeled off from the base substrate 8 by using, for example, a peeling device (not shown). At this time, the peeling device applies an adsorption force to the laminated sheets 5 from above and lifts it upward. As a result, the laminated sheets 5 are peeled off from the base substrate 8. The base substrate 8 is fixed to, for example, a conveying table (not shown) or the like.

Since the green sheets 7a and 7b are peeled off together from the base substrate 8, even if the average thickness of the green sheets 7a and 7b is reduced, possibility of damage is reduced because strength of the laminated sheets 5 are higher than that of each of the green sheets 7a and 7b. Therefore, the multilayer ceramic capacitor 1 having the thin dielectric layers 11 can be easily manufactured.

### Lamination and Pressure Bonding Process St6

In this process, multiple sets of laminated sheets 5, that is, a plurality of sets of the green sheets 7a and 7b are laminated and pressed. At this time, the multiple sets of laminated sheets 5 are sandwiched from the upper and lower sides in the lamination direction by other green sheets 7c and 7d which become the cover layers 13 after firing process, and pressure bonding is performed. On a surface of the lowermost green sheet 7d, the internal electrode patterns 6b are formed by the same method as the internal electrode pattern formation process St4. Examples of means for the pressure bonding include, but are not limited to, a hydrostatic press.

### Cutting Process St7

In this process, the pressed green sheets 7a to 7d are cut by, for example, a blade along a plurality of cut lines LW extending vertically and horizontally at a constant interval. Thus, the multiple sets of laminated sheets 5 are divided into a plurality of laminated bodies 7S before firing. Additionally, in FIG. 8, a cut line LW along the width direction of the laminated body 7S is shown, but a cut line along the length direction is not shown. End portions of the internal electrode patterns 6b, 6a are respectively exposed on the end surfaces 2A, 2B which are cut surfaces of the multilayer body. Although not shown, when the multiple sets of laminated sheets 5 are cut along the cut line along the length direction of the laminated body 7S, end portions of the internal electrode patterns 6a and 6b are exposed on the side surfaces 2E and 2F which are cut surfaces of the multilayer body. The side margin 16 before firing is formed on the side surfaces 2E and 2F by pressing a green sheet onto the side surfaces 2E and 2F so that the green sheet is partially sticking to the side surfaces 2E and 2F.

### External Electrode Formation Process St8

In this process, for example, metal paste containing metal powder, glass frits, a binder, and a solvent is applied to the end surfaces 2A and 2B, the upper surface 2C, the lower surface 2D, and the side surfaces 2E and 2F of the laminated body 7S by a dipping method. After the metal paste is applied, the metal paste is baked through the following firing process St9. Thus, the external electrodes 20a and 20b are formed.

### Firing Process St9

In this process, the unfired laminated body 7S is subjected to a de-binding treatment in an N2 atmosphere at 250 to 500° C. , and then fired in a reducing atmosphere having an oxygen partial pressure of 0.003 (Pa) at a firing temperature of 1200° C. or higher for about one hour, whereby particles in the laminated body 7S are sintered. Thus, in the laminated body 7S, the green sheets 7a to 7d become the dielectric layers 11 and the cover layers 13, and the internal electrode patterns 6a and 6b become the internal electrode layers 12a and 12b. Also, parts of the green sheets adhered to the side surfaces 2E and 2F of the laminated body 7S become the side margins 16.

Since the average thicknesses Ta and Tb of the internal electrode patterns 6a and 6b are different from each other, a difference is generated in the sintering property of the internal electrode patterns 6a and 6b during the firing process as described above, and the amount of shrinkage and the timing of shrinkage of the internal electrode patterns 6a and 6b are different from each other. Therefore, a difference between an amount of contraction of the internal electrode patterns 6a and 6b and an amount of contraction of the side margins 16 and the cover layers 13 is reduced, and a stress generated in the laminated body 7S can be effectively dispersed by the difference in the amount of contraction as compared with the case where the average thicknesses Ta and Tb are the same. This suppresses the occurrence of cracks in the laminated body 7S, and thus improves the reliability of the multilayer ceramic capacitor 100.

The present invention is not limited to the specific embodiments, and various modifications and changes are possible within the scope of the gist of the present invention described in the claims.

What is claimed is:

1. A multilayer ceramic electronic component comprising:
a substantially rectangular parallelepiped multilayer body in which a plurality of dielectric layers, a plurality of first internal electrode layers, and a plurality of second internal electrode layers are laminated,
wherein an average thickness of each of the plurality of first internal electrode layers is different from an average thickness of each of the plurality of second internal electrode layers, and
wherein the each of the plurality of first internal electrode layers and the each of the plurality of second internal electrode layers are alternately laminated with each of the plurality of dielectric layers interposed therebetween.

2. The multilayer ceramic electronic component according to claim 1, wherein
a ratio of the average thickness of the each of the plurality of the first internal electrode layers to the average thickness of the each of the plurality of the second internal electrode layers is 1.05 or more and 2.0 or less.

3. The multilayer ceramic electronic component according to claim 1, wherein
an average continuity modulus of the each of the plurality of first internal electrode layers is different from an average continuity modulus of the each of the plurality of second internal electrode layers.

4. The multilayer ceramic electronic component according to claim 3, wherein
a difference between the average continuity modulus of the each of the plurality of first internal electrode layers and the average continuity modulus of the each of the plurality of second internal electrode layers is 3% or more.

5. The multilayer ceramic electronic component according to claim 1, wherein
the plurality of first internal electrode layers and the plurality of second internal electrode layers respectively contain a rare earth element, and
concentration of the rare earth element in the each of the plurality of first internal electrode layers is different from concentration of the rare earth element in the each of the plurality of second internal electrode layers.

6. The multilayer ceramic electronic component according to claim 5, wherein
a difference between the concentration of the rare earth element in the each of the plurality of first internal electrode layers and the concentration of the rare earth element in the each of the plurality of second internal electrode layers is 5 at % or more.

7. The multilayer ceramic electronic component according to claim 1, wherein
the plurality of first internal electrode layers and the plurality of second internal electrode layers respectively contain a ceramic component, and
concentrations of the ceramic component in the each of the plurality of first internal electrode layers is different from concentration of the ceramic component in the each of the plurality of second internal electrode layers.

8. The multilayer ceramic electronic component according to claim 7, wherein
a difference between the concentration of the ceramic component in the each of the plurality of first internal electrode layers and the concentration of the ceramic component in the each of the plurality of second internal electrode layers is 0.1% or more and 1.0% or less.

9. A manufacturing method of a multilayer ceramic electronic component, comprising:
forming a first green sheet by applying a ceramic slurry onto a base substrate;
forming a first internal electrode pattern by applying conductive paste onto the first green sheet;
forming a second green sheet by applying a ceramic slurry onto the first green sheet and the first internal electrode pattern;
forming a second internal electrode pattern having an average thickness different from that of the first internal electrode pattern by applying conductive paste onto the second green sheet;
peeling the first green sheet and the second green sheet from the base substrate;
laminating and pressure-bonding a plurality of sets of the first green sheet and the second green sheet;
dividing the plurality of sets of the first green sheet and the second green sheet which have been pressure-bonded into a plurality of laminated bodies along a lamination direction; and
firing the laminated body.

10. The manufacturing method according to claim 9, wherein
an amount of the conductive paste applied on the first green sheet and an amount of the conductive paste applied on the second green sheet are different from each other.

11. The manufacturing method according to claim 9, wherein
in the forming the first internal electrode pattern and the forming the second internal electrode pattern, a ceramic component is added to the conductive paste, and
an amount of the ceramic component added to the conductive paste applied on the first green sheet is different from an amount of the ceramic component added to the conductive paste applied on the second green sheet.

12. The manufacturing method according to claim 9, wherein
in the forming the first internal electrode pattern and the forming the second internal electrode pattern, a rare earth element is added to the conductive paste, and
an amount of the rare earth element added to the conductive paste applied on the first green sheet is different from an amount of the rare earth element added to the conductive paste applied on the second green sheet.
